(19) United States
(12) Patent Application Publication
(10) Pub. No.: US 2009/0236855 A1
(43) Pub. Date: Sep. 24, 2009

(54) Water Powered Generator and Method of using same

(76) Inventor: Michael Jordan, Marlboro, NY (US)

Correspondence Address: GFD PATENTS, LLC, P.O. BOX 752, CLIFTON PARK, NY, 12065, US

(21) Appl. No.: 11/650,617

(22) Filed: Jan. 8, 2007

(51) Int. Cl. F03B 13/10

(52) U.S. Cl. 290/54

(57) ABSTRACT

This invention utilizes a self contained floating catamaran-type vehicle enclosing turbines and generators, and transmits electricity to a power grid or stores excess electricity on board until it can be transferred. When water hits the blades or paddles of a turbine, the blades or paddles spin around. A series of turbines are attached in line between the hulls of the catamaran, connected to one or more generators inside the hulls. The electricity is then either transmitted by lines to an on shore power grid or storage facility or stored in the catamaran in batteries or other type of storage medium. A connecting rod connects the turbine to the generator, which produces electricity. The electricity is then either transmitted by lines to an on shore storage and distribution network through cables and wires from the catamaran.

### FIELD OF THE INVENTION

The present invention generally relates to devices and methods for producing electricity. More specifically, the present invention relates to hydroelectric power generators and methods for producing electricity using hydroelectric power generators.

### BACKGROUND

Currently, electricity is produced most commonly using methods which cause pollution and deplete natural resources. There is a need for improved devices and methods which overcome these disadvantages.

### SUMMARY OF THE INVENTION

This invention has to do with hydroelectric power utilizing a self contained floating catamaran-type vehicle enclosing turbines and generators, plus the ability to transmit to a power grid or store excess electricity on board until it can be transferred.

The flowing water beneath the stationary catamaran turns the turbines, which in turn are attached to the generators creating electricity, which is either transmitted or stored on board. A series of turbines are attached in line between the hulls of the catamaran, connected to one or more generators inside the hulls. The electricity is then either transmitted by lines to an on shore power grid or storage facility or stored in the catamaran in batteries or other type of storage medium.

When water hits the blades or paddles of a turbine, the blades or paddles of the turbine spin around. A connecting rod connects the turbine to a generator, which produces electricity. The electricity is then either transmitted by lines to an on shore storage and distribution network through cables and wires from the catamaran.

A first aspect of the present invention provides a floating, water current-powered electrical generation plant, comprising: a catamaran, comprising :upper and lower platforms supported by first and second buoyant pontoons, so that the pontoons float in a flowing body of water, wherein the inwardly-facing lateral walls and outwardly-facing lateral walls of the first and second pontoon are substantially parallel; an elongate trench running along a longitudinal axis of the platforms between the pontoons, wherein the inwardly-facing lateral walls of the pontoons and a bottom surface of the lower platform form a trench, wherein the bottom surface of the lower platform faces an opening that is open to the flowing body of turbine comprising an array of rotatable first elongated shafts, wherein each turbine is located in the trench between the buoyant pontoons and is adapted for engagement with and rotation by water in said flowing body of water, wherein each rotatable first elongated shaft is rotatably coupled to one of the turbines and is rotatably coupled to the outwardly-facing lateral walls of the first and second pontoons; lower large gears, each having a diameter, wherein each lower large gear is rotatably coupled to the respective first elongated shaft; an array of electric generators, each electric generator comprising an array of rotatable second elongated shafts, wherein a first end of each second elongated shaft is rotatably coupled to one of the electric generators, and wherein an upper small gear having a second diameter is rotatably coupled to a second end of each second elongated shaft, wherein the lower large gear and upper small gear are rotatably coupled so that rotating the lower large gear rotates the upper small gear.

A second aspect of the present invention provides a method for generating electricity, comprising: providing a floating, water current-powered electrical generation plant in a catamaran, the floating, water current-powered electrical generation plant in a catamaran comprising: upper and lower platforms supported by first and second buoyant pontoons, so that the pontoons float in a flowing body of water, wherein the inwardly-facing lateral walls and outwardly-facing lateral walls of the first and second pontoon are substantially parallel; an elongate trench running along a longitudinal axis of the platforms between the pontoons, wherein the inwardly-facing lateral walls of the pontoons and a bottom surface of the lower platform form a trench, wherein the bottom surface of the lower platform faces an opening that is open to the flowing body of water; an array of turbines, wherein each turbine is located in the trench between the buoyant pontoons; rotatably coupling each turbine to an electrical generator; and adapting each turbine for engagement with and rotation by water in said flowing body of water.

### BRIEF DESCRIPTION OF THE DRAWINGS

The dimensions of components shown in the following drawings are not drawn to scale or meant to show relative sizes of the components. All measurements and sizes can be adapted according to environment and situation.

FIG. 1 depicts a top plan view of a floating, water current-powered electrical generation plant, according to embodiments of the present invention;

FIG. 2 depicts a bottom plan view of the floating, water current-powered electrical generation plant, according to embodiments of the present invention;

FIG. 3 depicts a top plan view of the floating, water current-powered electrical generation plant, according to embodiments of the present invention;

FIG. 4 depicts a transverse cross-sectional view of the floating, water current-powered electrical generation plant, according to embodiments of the present invention; and

FIGS. 5A-5B depict a flow sheet for a method for generating electricity, according to embodiments of the present invention.

### DETAILED DESCRIPTION OF EMBODIMENTS OF THE INVENTION

The data explaining the necessary information to obtain this patent for a self contained electric power generating plant utilizing free flowing water is as follows:

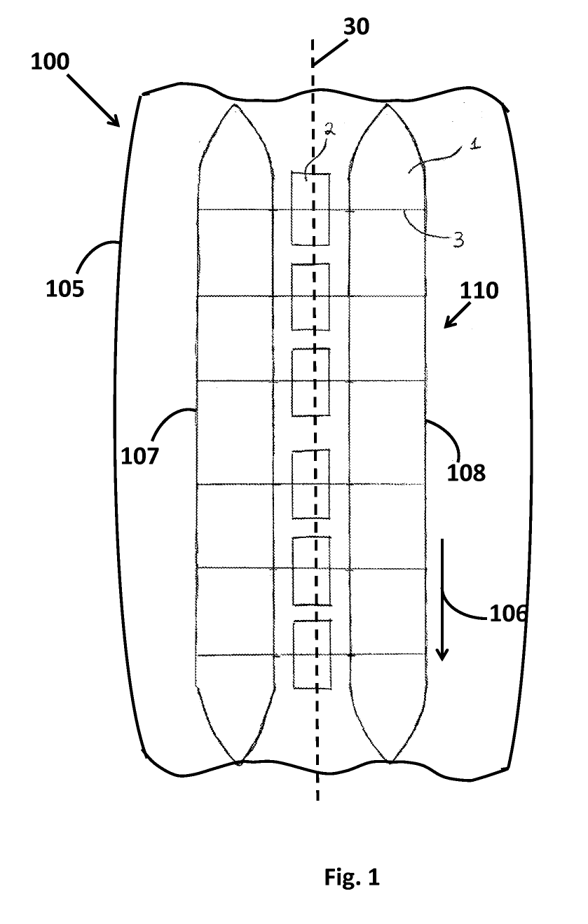

FIG. 1 depicts a top plan view of a floating, water current-powered electric electrical generation plant 100 in a catamaran 110, comprising: a catamaran 110, having pontoons 1; shafts 3, rotatably coupled to turbines 2, and extending from turbines 2 into and supported by pontoons 1. The water current-powered electric electrical generation plant 100 in a catamaran 110 floats on a flow of water 105, flowing in a direction of the arrow 106. Hereinafter, a catamaran is defined as a boat with twin essentially parallel hulls.

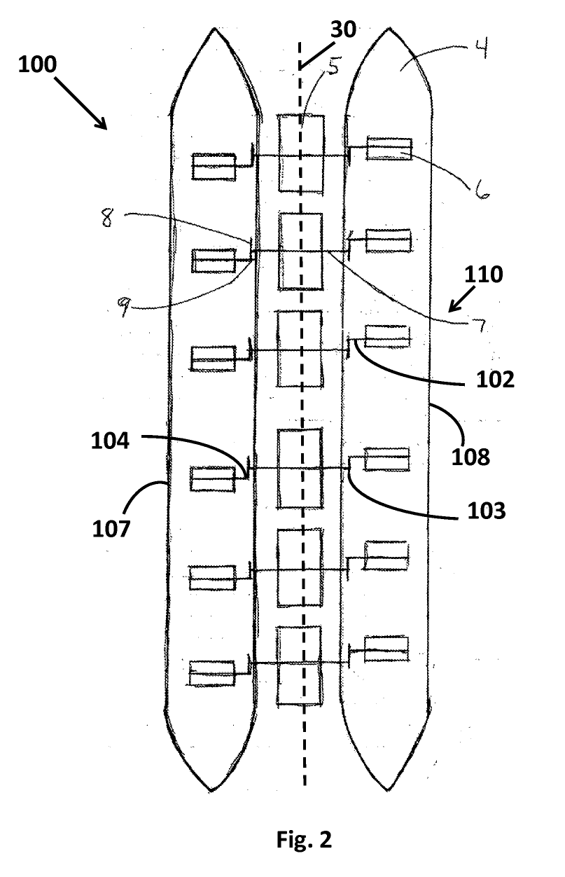

FIG. 2 depicts a bottom plan view of an electric power generating plant 100 in a catamaran 110, comprising: a catamaran 110, having pontoons 4; turbines 5; electrical generating unit 6; and shafts 7, 102 between the turbines 5 and electrical generating units 6. A distal end 104 of the shaft 102 is rotatably coupled to an upper small gear 9. A distal end 103 of the shaft 7 is rotatably coupled to a lower large gear 8. Hereinafter, “rotatably coupled” or “rotatably coupling” is defined as physically or mechanically joining pieces, such as shafts and gears, so that the joined pieces may rotate or pivot.

The lower large gear 8 connects to shaft 7, turning upper smaller gear 9 attached to generator (see 9 in FIG. 2). Upper small gear 9 turns at higher rate of speed than lower large gear 8, creating a greater amount of electricity in the generator.

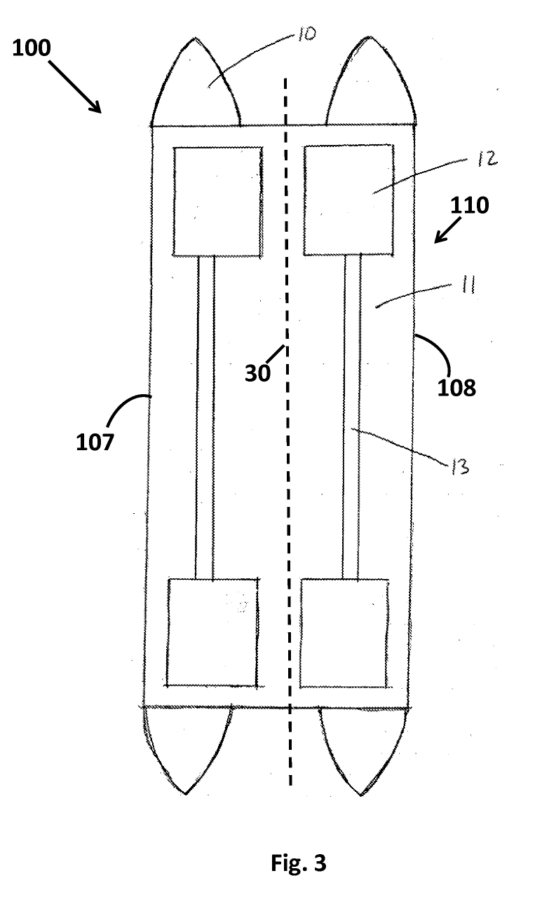

FIG. 3 depicts a top plan view of the electric power generating plant 100 in a catamaran 110, comprising: a catamaran 110, including pontoons 10, and an upper platform 11; an electrical transfer 12 from the generators 6 and electric cables 13 to go to an electric grid (electric grid not shown). The electrical transfer 12, 22 from the generators 6 includes necessary equipment for the transfer or storage of generated electricity. The electrical transfer 12 may be supported by the upper platform 11.

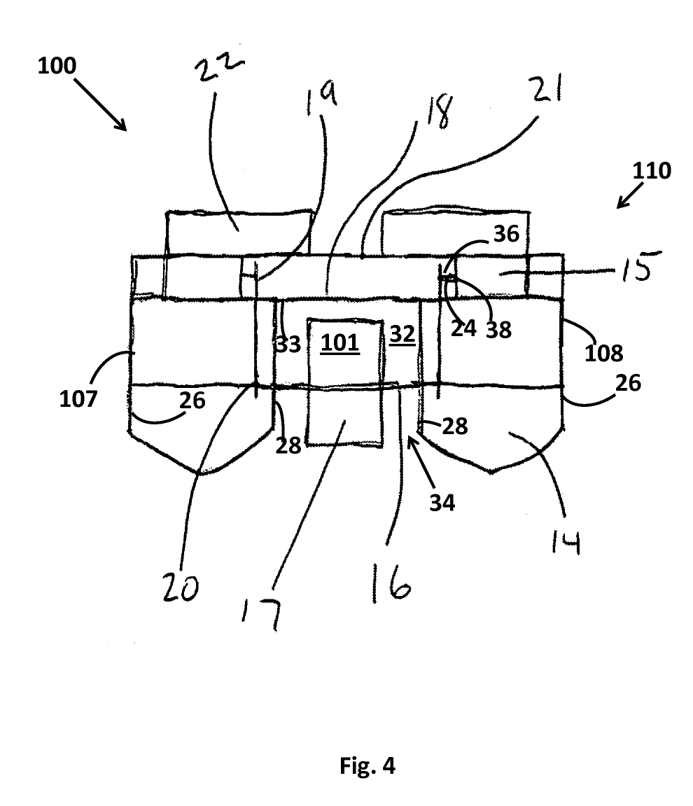

FIG. 4 depicts a transverse cross-sectional view of the electric power generating plant 100, comprising: a catamaran 108, wherein the catamaran 109 comprises: pontoons 14, turbines 17; upper platform 21; and lower platform 18.

The electric power generating plant 100 is best housed in a catamaran 110 or other floating or stationary vehicle sufficient to accommodate multiple turbines 2, 17 and electrical generating units 6, 15 and the necessary equipment for the transfer or storage of generated electricity, for example the electrical transfer 12, 22. The turbines 5 comprise blades or paddles 101.

This floating electric power generating plant 100 is best housed in a catamaran 110, or other floating or stationary vehicle sufficient to accommodate multiple turbines 2, 17 and electrical generating units 6, 15 and the necessary equipment for the transfer or storage of generated electricity.

These floating plants 100 can be anchored close to shore, in the middle of a river, or any other body of water 105, where it will not impede other traffic. The floating electric power generating plants 100 may utilize free flowing water 105 in the direction of arrow 106. It can also be utilized under bridges. They will house multiple turbines 2, 17 in line with sufficient space to not interfere with each other. Each turbine 2, 17 is connected to both sides 107, 108 of the catamaran 110 by a gear 8, 9, 19, 20 or other connecting device to generators 6, 15 within the body of the catamaran 110 capable of turning the generators 6, 15 at a high rate of speed for maximum generation of electricity. These floating electric power generating plants 100 include all other necessary equipment to transfer this electricity via connecting cables 13 to a distribution center where it is transferred to a main electrical grid (not shown), for example the electrical transfer 12, 22. Where this is not possible, accommodation can be made to store same into electric storage equipment, for example the electrical transfer 12, 22, within the confines of the catamaran 110. These units can be constructed in any size necessary to be accommodated by the water flow necessary to drive same.

There are a number of different types of turbines 5, 17 which can be used, either vertical or horizontal. Each would be used according to which is best suited for the depth of the water and the environment.

In each case, we will utilize the most efficient accessory equipment available, i.e. electrical generating units 6, 15 etc. to best suit our needs. These units 6, 15 will be able to operate in all seasons utilizing the equipment to protect it from any and all inclement weather conditions.

The water 105 hits the blades or paddles 101 of the turbine 2, 17, making the turbine 2, 17 spin around.

FIGS. 1-4 depict a floating, water current-powered electrical generation plant 100 in a catamaran 110. The catamaran 110 has upper and lower platforms 21, 11, and 18 supported by a plurality of buoyant pontoons 1, 4, 10, 14, so that the pontoons 1, 4, 10, 14 float in a flowing body of water 105, wherein the inwardly-facing lateral walls 28 and outwardly-facing lateral walls 26 of the a plurality of buoyant pontoons 1, 4, 10, 14 are substantially parallel.

The catamaran 110 may have an elongate trench 32 running along a longitudinal axis 30 catamaran 110 of the platforms 21, 18 between the pontoons 1, 4, 10, 14. The inwardly-facing lateral walls 28 of the pontoons 1, 4, 10, 14 and a bottom surface 33 of the lower platform 18 form the elongate trench 32. The bottom surface 33 of the lower platform 18 faces an opening 34 that is open to the flowing body of water 105.

The floating, water current-powered electrical generation plant 100 includes an array of turbines 2, 5, 17, each turbine 2, 5, 17 comprising an array of rotatable first elongated shafts 3, 7, 16. Each turbine 2, 5, 17 may be located in the elongate trench 32 between the buoyant pontoons 1, 4, 10, 14 and may be adapted for engagement with and rotation by water in said flowing body of water 105. Each rotatable first elongated shaft 3, 7, 16 may be rotatably coupled to one of the turbines 2, 5, 17 and may be rotatably coupled to the outwardly-facing lateral walls 26 of the plurality of buoyant pontoons 1, 4, 10, 14.

The floating, water current-powered electrical generation plant 100 includes lower large gears 8, 20, each having a first diameter, wherein each lower large gear 8, 20 may be rotatably coupled to the respective first elongated shaft 3, 7, 16.

The floating, water current-powered electrical generation plant 100 includes an array of electric generators 6,15, each electric generator 6, 15 comprising an array of rotatable second elongated shafts 24. A first end 38 of each second elongated shaft 24 may be rotatably coupled to one of the electric generators 6, 15. An upper small gear 9, 19 having a diameter may be rotatably coupled to a second end 36 of each second elongated shaft 24. The lower large gear 8, 20 and upper small gears 9, 19 may be rotatably coupled so that rotating the lower large gear 8, 20 rotates the upper small gear 9, 19.

In one embodiment, the floating, water current-powered electrical generation plant 100 comprises an array of electrical transfer from generator 12, 22, wherein each electrical transfer from generator 12, 22 may be conductively coupled to said electric generators 6,15 and wherein each electrical transfer from generator 12, 22 is supported by the upper platform 11, 21.

In one embodiment, each electric generator 6, 15 is supported by a portion of the lower platform 18 located above the plurality of buoyant pontoons 1, 4, 10, 14.

In one embodiment, the diameter of the lower large gear 8, 20 is larger than the diameter of the upper small gear 9, 19, so that the upper small gear 9, 19 rotates at a higher rate of speed than the lower large gear 8, 20.

In one embodiment, the electric transfer from generator 12, 22 comprises electric lines 13 to an on shore power grid or storage facility or a storage medium.

In one embodiment, each turbine 2, 5, 17 has paddles or blades 101, so that the turbine 2, 5, 17 spins around when the water hits the blades or paddles 101.

In one embodiment, an axis of rotation of each turbine 2, 5, 17 is either vertical or horizontal in respect to a direction of the flow of the water 106.

In one embodiment, the plant 100 may be anchored in a location selected from the group consisting of a location close to shore, a location in the middle of a river, and a location under a bridge.

In one embodiment, each turbine 2, 5, 17 may be rotatably coupled to each electric generator 6, 15 within a body of the catamaran 110.

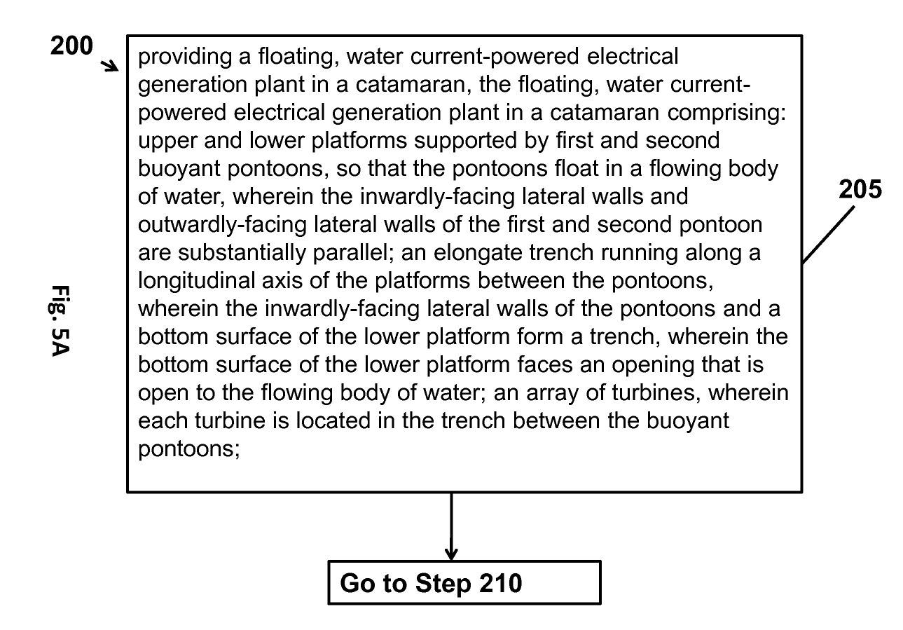

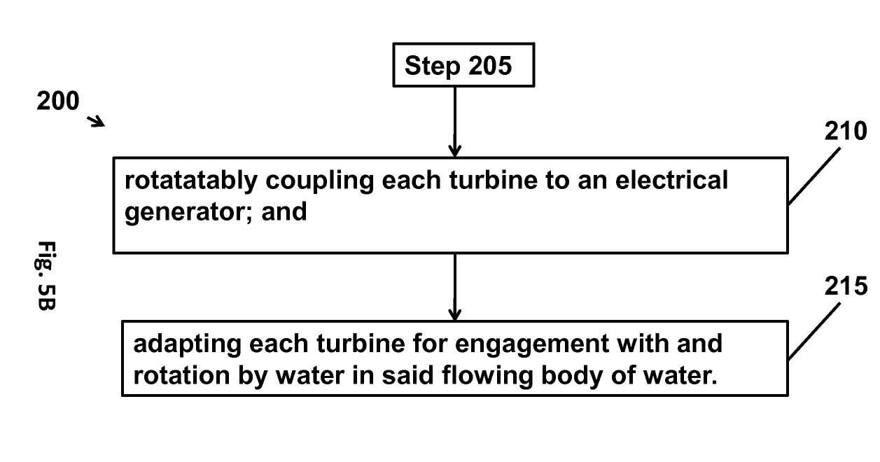

FIGS. 5A-5B depict a flow sheet for a method 200 for generating electricity. The method 200 comprises a step 205: providing a floating, water current-powered electrical generation plant 100 in a catamaran 110. The catamaran comprises: an upper platform 11, 21 and a lower platform 18 supported by buoyant pontoons 1, 4, 10, 14, so that the pontoons 1, 4, 10, 14 float in a flowing body of water 105. In the step 205, the inwardly-facing lateral walls 26 and outwardly-facing lateral walls 28 of the pontoons 1, 4, 10, 14 are substantially parallel. The catamaran 110 comprises an elongate trench 34 running along a longitudinal axis 30 of the platforms 11, 21, and 18 between the pontoons 1, 4, 10, 14. The inwardly-facing lateral walls 26 of the pontoons 1, 4, 10, 14, and a bottom surface 33 of the lower platform 18 form a trench 32. The bottom surface 33 of the lower platform 18 faces an opening 34 that is open to the flowing body of water 105.

In the step 205 of the method 200, the floating, water current-powered electrical generation plant 100 in the catamaran 110 comprises an array of turbines 2, 5, 17, wherein each turbine 2, 5, 17 is located in the elongated trench 32 between the buoyant pontoons 1, 4, 10, 14.

In a step 210 of the method 200, each turbine 2, 5, 17 is adapted for engagement with and rotation by water in said flowing body of water 105; and

In a step 215 of the method 200, each turbine 2, 5, 17 is rotatatably coupled to an electrical generator 6, 15.

In one embodiment, the step 215 of the method 200 for generating electricity comprises transferring from the electric transfer from generator 12, 22 to electric lines to an on shore power grid or storage facility or a storage medium.

In one embodiment, the step 210 of the method 200 for generating electricity, each turbine 2, 5, 17 has paddles or blades 101, so that the turbine 2, 5, 17 spins around when the water hits the blades or paddles 101.

In one embodiment of the step 210 of the method 200 for generating electricity, turbine 2, 5, 17, an axis of rotation of each turbine 2, 5, 17 is either vertical or horizontal in respect to a direction of the arrow 106 of the flow of water 105.

In one embodiment of the steps 205-215 of the method 200 for generating electricity, the plant 100 is anchored in a location selected from the group consisting of a location close to shore, a location in the middle of a river, and a location under a bridge.

In one embodiment of the step 205 of the method 200 for generating electricity, each turbine 2, 5, 17 of the array of turbines 2, 5, 17 comprise rotatable first elongated shafts 3, 7, 16, wherein each rotatable first elongated shaft 3, 7, 16 is rotatably coupled to one of the turbines 2, 5, 17 and is rotatably coupled to the outwardly-facing lateral walls 26 of the buoyant pontoons 1, 4, 10, 14.

In one embodiment of the step 205 of the method 200 for generating electricity, each rotatable first elongated shaft 3, 7, 16 comprises a lower large gear 8, 20 having a diameter, wherein each lower large gear 8, 20 is rotatably coupled to the respective first elongated shaft 3, 7, 16.

In one embodiment of the step 210 of the method 200 for generating electricity, each turbine 2, 5, 17 is located in the trench 32 between the buoyant pontoons 1, 4, 10, 14 and is adapted for engagement with and rotation by water in said flowing body of water 105.

In one embodiment of the step 205 of the method 200 for generating electricity, each turbine 2, 5, 17 comprises an array of rotatable first elongated shafts 3, 7, 16. Each rotatable first elongated shaft 3, 7, 16 comprises lower large gears 8, 20, each having a diameter. Each lower large gear 8, 20 is rotatably coupled to the first elongated shaft 3, 7, 16. Each first elongated shaft 3, 7, 16 is rotatably coupled to one of the turbines 2, 5, 17 and is rotatably coupled to the outwardly-facing lateral walls 26 of the buoyant pontoons 1, 4, 10, 14.

In one embodiment, the step 215 of the method 200 for generating electricity, each electric generator 6, 15 comprises an array of rotatable second elongated shafts 24, wherein a first end 38 of each second elongated shaft 24 is rotatably coupled to one of the electric generators 6, 15. An upper small gear 9, 19 having a second diameter is rotatably coupled to a second end 36 of each second elongated shaft 24, wherein the lower large gear 8, 20 and upper small gear 9, 19 are rotatably coupled so that rotating the lower large gear 8, 20 rotates the upper small gear 9, 19.

In one embodiment of the step 215 of the method 200 for generating electricity, the diameter of the lower large gear 8, 20 is larger than the diameter of the upper small gear 9, 19, so that the upper small gear 9, 19 rotates at a higher rate of speed than the lower large gear 8, 20.

In one embodiment of the step 215 of the method 200 for generating electricity, each electric generator 6, 15 is supported by a portion of the lower platform 18 located above the pontoons 1, 4, 10, 14.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

I claim:

1. A floating, water current-powered electrical generation plant, comprising:
a catamaran, comprising:
upper and lower platforms supported by first and second buoyant pontoons, so that the pontoons float in a flowing body of water, wherein the inwardly-facing lateral walls and outwardly-facing lateral walls of the first and second pontoon are substantially parallel;
an elongate trench running along a longitudinal axis of the platforms between the pontoons, wherein the inwardly-facing lateral walls of the pontoons and a bottom surface of the lower platform form a trench, wherein the bottom surface of the lower platform faces an opening that is open to the flowing body of water;
an array of turbines, each turbine comprising an array of rotatable first elongated shafts, wherein each turbine is located in the trench between the buoyant pontoons and is adapted for engagement with and rotation by water in said flowing body of water, wherein each rotatable first elongated shaft is rotatably coupled to one of the turbines and is rotatably coupled to the outwardly-facing lateral walls of the first and second pontoons;
lower large gears, each having a diameter, wherein each lower large gear is rotatably coupled to the respective first elongated shaft;
an array of electric generators, each electric generator comprising an array of rotatable second elongated shafts, wherein a first end of each second elongated shaft is rotatably coupled to one of the electric generators, and wherein an upper small gear having a second diameter is rotatably coupled to a second end of each second elongated shaft, wherein the lower large gear and upper small gear are rotatably coupled so that rotating the lower large gear rotates the upper small gear.

2. The floating, water current-powered electrical generation plant of claim 1, comprising an array of electrical transfers from the generators, wherein each electrical transfer from the generator is conductively coupled to said electric generators, and wherein each electrical transfer from the generator is supported by the upper platform.

3. The floating, water current-powered electrical generation plant of claim 1, wherein each electric generator is supported by a portion of the lower platform located above the first and second pontoons.

4. The floating, water current-powered electrical generation plant of claim 1, wherein the diameter of the lower large gear is larger than the diameter of the upper small gear, so that the upper small gear rotates at a higher rate of speed than the lower large gear.

5. The floating, water current-powered electrical generation plant of claim 1, the electric transfer from the generators comprising electric lines to an on shore power grid or storage facility or a storage medium.

6. The floating, water current-powered electrical generation plant of claim 1, wherein each turbine has paddles or blades, so that the turbine spins around when the water hits the blades or paddles.

7. The floating, water current-powered electrical generation plant of claim 1, wherein an axis of rotation of each turbine is either vertical or horizontal in respect to a direction of the flow of the water.

8. The floating, water current-powered electrical generation plant of claim 1, wherein the plant is anchored in a location selected from the group consisting of a location close to shore, a location in the middle of a river, and a location under a bridge.

9. The floating, water current-powered electrical generation plant of claim 1, wherein each turbine is rotatably coupled to each generator within a body of the catamaran.

10. A method for generating electricity, comprising:
providing a floating, water current-powered electrical generation plant in a catamaran, the floating, water current-powered electrical generation plant in a catamaran comprising:
upper and lower platforms supported by first and second buoyant pontoons, so that the pontoons float in a flowing body of water, wherein the inwardly-facing lateral walls and outwardly-facing lateral walls of the first and second pontoon are substantially parallel;
an elongate trench running along a longitudinal axis of the platforms between the pontoons, wherein the inwardly-facing lateral walls of the pontoons and a bottom surface of the lower platform form a trench, wherein the bottom surface of the lower platform faces an opening that is open to the flowing body of water;
an array of turbines, wherein each turbine is located in the trench between the buoyant pontoons;
rotatatably coupling each turbine to an electrical generator; and
adapting each turbine for engagement with and rotation by water in said flowing body of water.

11. The method of generating electricity of claim 10, comprising transferring from the electric transfer from generator to electric lines to an on shore power grid or storage facility or a storage medium.

12. The method of generating electricity of claim 10, wherein each turbine has paddles or blades, so that the turbine spins around when the water hits the blades or paddles.

13. The method of generating electricity of claim 10, wherein an axis of rotation of each turbine is either vertical or horizontal in respect to a direction of the flow of the water.

14. The method of generating electricity of claim 10, comprising anchoring the plant in a location selected from the group consisting of a location close to shore, a location in the middle of a river, and a location under a bridge.

15. The method of generating electricity of claim 10, wherein each turbine of the array of turbines comprises rotatable first elongated shafts, wherein each rotatable first elongated shaft is rotatably coupled to one of the turbines and is rotatably coupled to the outwardly-facing lateral walls of the buoyant pontoons.

16. The method of generating electricity of claim 15, wherein each rotatable first elongated shaft comprises a lower large gear having a diameter, wherein each lower large gear is rotatably coupled to the respective first elongated shaft.

17. The method of generating electricity of claim 10, wherein each turbine is located in the trench between the buoyant pontoons and is adapted for engagement with and rotation by water in said flowing body of water.

18. The method of generating electricity of claim 10, wherein each turbine comprises an array of rotatable first elongated shafts, wherein each rotatable first elongated shaft comprises a lower large gear, each having a diameter, wherein each lower large gear is rotatably coupled the first elongated shaft, wherein each first elongated shaft is rotatably coupled to one of the turbines and is rotatably coupled to the outwardly-facing lateral walls of the first and second pontoons, and wherein each electric generator comprises an array of rotatable second elongated shafts, wherein a first end of each second elongated shaft is rotatably coupled to one of the electric generators, and wherein an upper small gear having a diameter is rotatably coupled to a second end of each second elongated shaft, wherein the lower large gear and upper small gear are rotatably coupled so that rotating the lower large gear rotates the upper small gear.

19. The method of generating electricity of claim 18, wherein the diameter of the lower large gear is larger than the diameter of the upper small gear, so that the upper small gear rotates at a higher rate of speed than the lower large gear.

20. The method of generating electricity of claim 10, wherein each electric generator is supported by a portion of the lower platform located above the first and second pontoons.
